(19) United States
(12) Patent Application Publication
(10) Pub. No.: US 2026/0182489 A1
(43) Pub. Date: Jul. 2, 2026

(54) SOWING AND SEEDLING CULTIVATION METHOD FOR SHANIODENDRON SUBAEQUALE

(71) Applicant: Anhui Agricultural University, Hefei (CN)

(72) Inventors: Rui Liu, Hefei (CN); Xijun Liu, Hefei (CN); Su Ma, Hefei (CN); Yinqi Bo, Hefei (CN); Huilin Xu, Hefei (CN); Xuebao Li, Hefei (CN); Yang Ji, Hefei (CN)

(21) Appl. No.: 19/382,201

(22) Filed: Nov. 6, 2025

(30) Foreign Application Priority Data
Dec. 30, 2024 (CN) 202411967107.3

(51) Int. Cl. A01C 1/02; A01C 1/04; A01C 7/00; A01C 21/00; A01M 7/00

(52) U.S. Cl. CPC A01C 1/02; A01C 1/04; A01C 7/006; A01C 21/005; A01M 7/0003

(57) ABSTRACT

A sowing and seedling cultivation method for Shaniodendron subaequale is provided, which relates to the field of plant seedling technologies. The method includes: collecting seeds from mid-September to early-October; removing impurities and air-drying the seeds until a seed moisture content is 8%-10%; performing sand storage on the seeds for overwintering by dynamically controlling humidity and using a sand-seed-sand layering method, and performing turning and disinfection on the seeds during the sand storage; sowing the seeds on a seedbed when a seed germination rate reaches 20%-30% in a following year, and covering the seeds with fine soil and dry grass; and removing the dry grass gradually when cotyledons of 20%-30% of seedlings are unfolded, and performing conventional seedling management. The method achieves a seedling emergence rate of 80%-85% and a seedling survival rate of 95%-98% for Shaniodendron subaequale. The cultivated seedlings are robust and exhibit strong adaptability to the environment.

### CROSS-REFERENCE TO RELATED APPLICATION

This application claims priority to Chinese Patent Application No. 202411967107.3, filed on Dec. 30, 2024, which is herein incorporated by reference in its entirety.

### TECHNICAL FIELD

The disclosure relates to the field of plant seedling technologies, and more particularly to a sowing and seedling cultivation method for Shaniodendron subaequale.

### BACKGROUND

Shaniodendron subaequale is a deciduous tree or small tree belonging to the family Hamamelidaceae and the genus Shaniodendron. Shaniodendron subaequale was discovered in the late 1950s. Along with Ginkgo biloba and Metasequoia glyptostroboides, it is considered one of the most ancient species of angiosperms and has now been included in the list of national key protected endangered plants, classified as a national first-level protected tree species. Shaniodendron subaequale has capitate inflorescences, bracts that are oval or broadly oval, a calyx tube shaped like a shallow cup with wavy blunt teeth at the edges, and no petals. Shaniodendron subaequale possesses 5-15 stamens with filaments that are slender, thread-like, and pendulous, hence the name “silver thread” in Chinese. The fruit of Shaniodendron subaequale is a capsule, and the seeds of Shaniodendron subaequale are spindle-shaped, approximately the size of a grain of rice, about 3 millimeters (mm) to 4 mm long, pointed at both ends, brown and glossy, with a light yellow hilum. The wild populations of Shaniodendron subaequale are distributed in the Dabie Mountain area and the Huangshan Mountains north of the Tianmu Mountains of Anhui, Zhejiang, Henan, and Chongqing, as well as in the Yili mountainous area southeastern of Jiangsu province.

Due to a narrow distribution range of Shaniodendron subaequale, extremely small number of existing plants, and the fact that it only blooms once every several years, Shaniodendron subaequale is facing extinction. Therefore, there is an urgent need for artificial propagation techniques to improve the seed germination rate and seedling emergence rate of Shaniodendron subaequale, thereby enhancing the protection of germplasm resources of Shaniodendron subaequale. In the related art, there are few methods for improving the seedling emergence rate and seedling survival rate of Shaniodendron subaequale. A report discloses the use of gibberellin soaking to break the endogenous dormancy of seeds of Shaniodendron subaequale. However, artificially breaking the endogenous dormancy of seeds may affect the seedling survival rate. Furthermore, problems in traditional sowing and seedling cultivation of Shaniodendron subaequale, such as inaccurate determination of seed maturity at the time of collection, susceptibility of seeds to mold during low-temperature storage, and low success rates of seedling cultivation, also need to be resolved urgently.

### SUMMARY

In order to solve the above technical problems, the disclosure provides a sowing and seedling cultivation method for Shaniodendron subaequale. A seedling emergence rate of the Shaniodendron subaequale cultivated by the method provided by the disclosure can reach 80% to 85%, a seedling survival rate of can reach 95% to 98%, and the seedlings are robust and have strong adaptability to environmental growth.

The disclosure provides a sowing and seedling cultivation method for Shaniodendron subaequale, including the following steps:
seed collection: collecting seeds of Shaniodendron subaequale from mid-September (i.e., 11 September to 20 September) to early-October (i.e., 1 October to 10 October) each year;
seed treatment: removing impurities and air-drying the seeds until a seed moisture content is 8% to 10%;
seed storage: performing sand storage on disinfected seeds for overwintering by using a sand-seed-sand layering method; controlling a relative humidity to 15% to 20% during a first month of sand storage, controlling the relative humidity to 21% to 25% from a second month to a beginning of a third month of the sand storage, and controlling the relative humidity to 30% to 50% during a later period of the sand storage; and performing turning and disinfection on the disinfected seeds during the sand storage to obtain seeds after sand storage;
sowing: sowing the seeds after sand storage on a seedbed when a seed germination rate reaches 20% to 30% in a following year, and covering the seeds after sand storage with a layer of fine soil and a layer of dry grass, sequentially; and
seedling management: removing the layer of dry grass gradually when cotyledons of 20% to 30% of seedlings are unfolded, and performing the seedling management.

In an embodiment, a time for the seed collection is the early-October each year.

In an embodiment, the layering method includes:
laying the disinfected seeds on a layer of disinfected river sand with a thickness of 5 centimeters (cm) to 8 cm, and covering a layer of the disinfected river sand with a thickness of 3 cm to 4 cm on the disinfected seeds.

In an embodiment, the performing turning and disinfection on the disinfected seeds during the sand storage in the seed storage to obtain seeds after sand storage includes:
taking out the seeds after sand storage, removing river sand from surfaces of the seeds after sand storage to obtain cleaned seeds, disinfecting the cleaned seeds by soaking in a potassium permanganate solution with a concentration of 0.3 grams per liter (g/L) to 0.5 g/L for 30 minutes (min) to 40 min to obtain re-disinfected seeds, and restoring the re-disinfected seeds to sand storage according to the layering method.

In an embodiment, the turning and disinfection is performed once per month during the seed storage.

In an embodiment, a temperature of the sand storage is in a range of 6° C. to 10° C.

In an embodiment, the seedbed is applied with 140 kilograms (kg) to 160 kg of cake fertilizer, 8 kg to 12 kg of plant iron supplement, and 2 kg to 3 kg of organophosphorus insecticide per mu (i.e., 666.67 square meters, abbreviated as m²).

In an embodiment, the seedbed is applied with 150 kg of cake fertilizer, 10 kg of plant iron supplement, and 3 kg of organophosphorus insecticide per mu.

In an embodiment, the cake fertilizer is a fermented cake fertilizer selected from the group consisting of rapeseed cake, bean cake, sesame cake, peanut cake, and cottonseed cake.

In an embodiment, the plant iron supplement is ferrous sulfate, and the organophosphorus insecticide is crystal trichlorphon (i.e., dimethyl (2,2,2-trichloro-1-hydroxyethyl)phosphonate, C₄H₈Cl₃O₄P).

In an embodiment, the seedling management further includes: spraying a bactericide after removing the layer of dry grass, applying a nitrogen fertilizer during a fast-growing period of the seedlings, and applying a phosphorus-potassium fertilizer in late-September (i.e., 21 September to 30 September).

In summary, compared with the related art, the disclosure has the following beneficial advantages and effects.
(1) The disclosure provides a sowing and seedling cultivation method for Shaniodendron subaequale, including seed collection, seed treatment, seed storage, seedbed preparation, sowing, and seedling management. The sowing and seedling method provided by the disclosure can increase the seed germination rate of Shaniodendron subaequale to 80% to 85%, and increase a seedling survival rate of Shaniodendron subaequale to 95% to 98%. Furthermore, the seedlings of Shaniodendron subaequale grow robustly and exhibit strong vitality. The method of the disclosure has advantages of simple operation, ease of mastery, and low cost. Shaniodendron subaequale flowers are extremely rare, blooming approximately once every 2 to 5 years, so that the seed source of the rare and endangered plant, Shaniodendron subaequale, is extremely precious. The disclosure holds significant practical importance for the resource conservation, scientific research, and development and utilization of the Shaniodendron subaequale species.
(2) In the method of the disclosure, the seed collection period is from mid-September to early-October. During this period, the fruits have turned yellowish, a part of the fruit husks have split open, and the seeds appear dark brown and are about the size of a grain of rice. The seeds have a high degree of maturity, contain abundant nutrients, and possess superior quality, making them suitable for collection and propagation. When seed collection is performed earlier than specified in the disclosure, the collected seeds have lower plumpness, are not fully mature, and the seedling emergence rate and the seedling survival rate are low, thereby leading to a waste of precious seed sources. When seed collection is performed later than specified in the disclosure, the fruits of Shaniodendron subaequale mature and split open, causing the seeds to automatically fall and scatter on the ground, where they are either eaten by animals or dispersed by wind, making it impossible to collect sufficient seeds. Furthermore, in the late stage of seed maturity, the seeds often become hollow, and their quality deteriorates.
(3) The method of the disclosure employs a dynamic humidity control strategy, which can ensure the seed germination rate of Shaniodendron subaequale and their safe overwintering. The benefits are manifested as follows. Firstly, the initial stage utilizes a low-temperature, sand storage method. This low-temperature and low-humidity environment temporarily induces the seeds into a state of forced dormancy, thereby maintaining minimal life activities of the seeds. Additionally, the “sand-seed-sand” layered storage method prevents oxygen deprivation and mold caused by lack of aeration during seed storage. The disinfected river sand has specific moisture and oxygen content, which is crucial for maintaining seed life activities and promoting post-ripening. When the temperature and humidity are higher, microbial activity will increase, thereby leading to mold formation. Therefore, the method described herein employs repeated disinfection and layered treatment to prevent mold occurrence. Secondly, the increased humidity in the later stage is conducive to promoting germination.
(4) Adequate nutrient supply is key to ensuring seedling emergence. The method of the disclosure can effectively increase the seedling emergence rate of Shaniodendron subaequale, and improve the seedling survival rate and yield through the application of sufficient base fertilizer to the seedbed during the sowing and seedling cultivation process, covering the seeds with fine soil and dry grass after sowing, and controls such as seedling disinfection, combined with appropriate fertilization later. The main reasons are as follows. Firstly, during the sowing and seedling cultivation stage, adequate nutrient supply and healthy soil can provide a favorable environment for seed germination and seedling growth, which is not easy to occur pests, diseases, and root toxicity. The fermented cake fertilizer has high readily available nutrient content, which facilitates absorption by Shaniodendron subaequale. Secondly, covering with fine soil fills the gaps between the seeds and the soil in the sowing holes, which ensures close contact between seeds and soil, and is beneficial for water absorption by the seeds and root growth of Shaniodendron subaequale. Covering with dry grass and its timely removal not only helps maintain temperature during seed germination, resulting in uniform seedling emergence, but also eliminates adverse effects of the grass cover, such as bending and shading of the seedlings. Thirdly, when temperature and humidity are high during the grass cover period, pathogen growth may be encouraged. Timely spraying of bactericide removes this hidden danger. During the entire fast-growing period of the seedlings, due to the high demand for nutrients, nitrogen fertilizer should be applied multiple times. In the later stage of seedling growth, it is necessary to promote lignification of the seedlings, reduce nitrogen fertilizer, increase phosphorus and potassium fertilizer, promote root growth, and prepare for leaf fall and overwintering.

### DETAILED DESCRIPTION OF EMBODIMENTS

In order to enable those skilled in the art to better understand technical solution of the disclosure and implement the technical solution of the disclosure, the disclosure will be further explained in conjunction with specific embodiments.

In the description of the disclosure, unless otherwise specified, all reagents used are commercially available and all methods used are conventional techniques in the art.

The seeds of Shaniodendron subaequale in the embodiments of the disclosure are taken from a mother tree of Shaniodendron subaequale within the Tianma National Nature Reserve in Jinzhai, Anhui Province.

The nationally protected tree species, Shaniodendron subaequale, has a narrow distribution area, very few surviving plants, and occasional flowering every few years, which is on the brink of extinction and urgently needs protective measures for artificial propagation of Shaniodendron subaequale. At present, there are few reports on the sowing and seedling cultivation of Shaniodendron subaequale. The problems in current sowing and seedling cultivation of Shaniodendron subaequale, such as inaccurate determination of seed maturity at the time of collection, susceptibility of seeds to mold during low-temperature storage, and low success rates of seedling cultivation, need to be resolved urgently.

The disclosure provides a sowing and seedling cultivation method for Shaniodendron subaequale, specifically including the following steps. Firstly, seed collection of Shaniodendron subaequale is completed from mid-September (i.e., 11 September to 20 September) to early-October (i.e., 1 October to 10 October) each year. Impurities are removed from the collected seeds, and the seeds are air-dried until a seed moisture content is 8% to 10%. Secondly, the seeds are subject to sand storage for overwintering and turning and disinfection of the seeds are performed during the sand storage by dynamically controlling humidity and adopting a “sand-seed-sand” layering method. The seeds are sown on a seedbed when a seed germination rate reaches 20% to 30% in a following year. A layer of fine soil and a layer of dry grass are sequentially covered on the seeds after sowing. The layer of dry grass is gradually removed when cotyledons of 20% to 30% of seedlings are unfolded. Conventional seedling management is performed thereafter. The method provided by the disclosure achieves a seedling emergence rate of 80% to 85% and a seedling survival rate of 95% to 98% for Shaniodendron subaequale. The cultivated seedlings are robust and exhibit strong adaptability to the environment.

### Embodiment 1

A sowing and seedling cultivation method for Shaniodendron subaequale includes the following steps.

### S1, Seed Collection

Fruits of Shaniodendron subaequale are collected in early-October (i.e., 1 October to 10 October).

### S2, Seed Treatment

The picked fruits are spread outdoors under weak light for sun-drying, and are turned during the process. After all fruits split open, the seeds are separated from the fruits. Seed shells and impurities are manually removed. The seeds are placed into cloth bags and hung indoors for air-drying until the seed moisture content reaches 9%, to remove surface and internal moisture.

### S3, Seed Storage

The impurities-removed and air-dried seeds are subjected to sand storage in a beginning of January of the following year, at a sand storage temperature of 8° C.
(1) River sand treatment: river sand obtained by sieving is disinfected by using a 1 g/L potassium permanganate solution.
(2) Seed treatment: seeds are soaked in a 0.5 g/L potassium permanganate solution for 0.5 hour (h).
(3) Seed burial: a layer of the river sand from step (1) with a thickness of 6 cm is evenly spread on the ground. A layer of seeds is then spread flat on the river sand, followed by covering with a layer of the river sand from step (1) with a thickness of 4 cm. A relative humidity of the river sand is controlled at 20% during a first month of the sand storage. The relative humidity is controlled at 25% from a second month to a beginning of a third month of the sand storage. The relative humidity is controlled at 40% during a later period of the sand storage. Frequent observation is conducted to prevent the seeds from drying out or molding.
(4) Seed turning: the seeds are turned once per month to release gases such as carbon dioxide produced by seed respiration. The river sand on the seed surfaces is removed by using a rice sieve, and the seeds are disinfected again with a 0.5 g/L potassium permanganate solution before being restored to sand storage.

### S4, Sowing

A nursery site with flat terrain, good drainage, and sandy loam soil having a power of hydrogen (pH) value of 6.1 is selected. Land preparation began in mid-February (i.e., 11 February to 20 February), which involves at least two rounds of plowing and harrowing until soil clods are broken and the nursery site is level. A ditch system is established to ensure unimpeded irrigation and drainage. 150 kg of fermented cake fertilizer is applied as base fertilizer per mu (i.e., 666.67 square meters, abbreviated as m²), and 10 kg of ferrous sulfate and 3 kg of 90% crystal trichlorfon are used for soil disinfection and eradication of soil pests, respectively. Seedbeds are oriented north-south to facilitate light exposure for growth of Shaniodendron subaequale. A height of the seedbed is 25 cm, and a width of the seedbed surface is 1.2 meters (m), with the center slightly higher than the sides to facilitate drainage. Since the seeds of Shaniodendron subaequale are small, the seedbed surface must be level.

During sowing, the seedbed surface is first sprayed with water to moisten the seedbed surface. Seeds with a 25% germination rate are evenly scattered on the seedbed surface. Due to the small quantity of seeds of Shaniodendron subaequale, they are uniformly covered with finely crushed yellow core soil with a thickness of 2 mm, followed by a layer of dry grass with a thickness of 5 mm for heat preservation and moisture retention, which facilitates seedling growth. Water is then sprayed thoroughly to soak the seedbed, which both maintains seedbed surface moisture and helps the covered dry grass lie flat on the seedbed, thereby preventing the covered dry grass from being blown away by wind. The layer of dry grass is then weighed down with branches. Fences are installed around the seedling field to prevent damage by people and livestock.

### S5, Seedling Management

7 days (d) after sowing, the layer of dry grass is partially removed to check seedling emergence. When the cotyledons of 20% of the seedlings are unfolded, a first batch of the dry grass is removed. The dry grass removal is completed in three batches. The dry grass removal is performed on overcast days to prevent exposing the seedlings to strong sunlight on clear days. The seeds develop roots before the dry grass is removed, thereby ensuring the seedling emergence rate and increasing seedling yield. All dry grass needs to be completely removed within 20 d. Delayed removal may lead to the formation of spindly seedlings. After dry grass removal, one round of weeding is performed. After a total of six weedings during the entire seedling period, the seedlings are basically canopy-closed by September. Throughout the growth period, attention is paid to cleaning ditches and drainage to prevent waterlogging of the seedlings, and timely watering or flood irrigation is carried out during droughts.

In the later stage after dry grass removal, carbendazim (1 h-benzimidazole-2-carbamic acid methyl ester, C₉H₉N₃O₂) is sprayed once to prevent seedling damping-off. During the fast-growing period of the seedlings, a 0.3% urea foliar fertilizer is sprayed every half month. In late-September (i.e., 21 September to 30 September) each year, a 3.0% monopotassium phosphate solution is sprayed three times to promote root growth and early lignification of the seedlings. Topdressing should follow the principle of “small amounts, multiple applications” to minimize impact on seedling growth. When pests appear, insecticides are sprayed.

### Embodiment 2

A sowing and seedling cultivation method for Shaniodendron subaequale includes the following steps.

### S1, Seed Collection

Fruits of Shaniodendron subaequale are collected in mid-September.

### S2, Seed Treatment

The picked fruits are spread outdoors under weak light for sun-drying, and are turned during the process. After all fruits split open, the seeds are separated from the fruits. Seed shells and impurities are manually removed. The seeds are placed into cloth bags and hung indoors for air-drying until the seed moisture content reaches 8%, to remove surface and internal moisture.

### S3, Seed Storage

The impurities-removed and air-dried seeds are subjected to sand storage in a beginning of January of the following year, at a sand storage temperature of 6° C.
(1) River sand treatment: river sand obtained by sieving is disinfected by using a 1 g/L potassium permanganate solution.
(2) Seed treatment: seeds are soaked in a 0.5 g/L potassium permanganate solution for 0.5 h.
(3) Seed burial: a layer of the river sand from step (1) with a thickness of 8 cm is evenly spread on the ground. A layer of seeds is then spread flat on the river sand, followed by covering with a layer of the river sand from step (1) with a thickness of 4 cm. A relative humidity of the river sand is controlled at 15% during a first month of the sand storage. The relative humidity is controlled at 21% from a second month to a beginning of a third month of the sand storage. The relative humidity is controlled at 30% during a later period of the sand storage. Frequent observation is conducted to prevent the seeds from drying out or molding.
(4) Seed turning: the seeds are turned once per month to release gases such as carbon dioxide produced by seed respiration. The river sand on the seed surfaces is removed by using a rice sieve, and the seeds are disinfected again with a 0.5 g/L potassium permanganate solution before being restored to sand storage.

### S4, Sowing

A nursery site with flat terrain, good drainage, and sandy loam soil having a pH value of 6.0 is selected. Land preparation began in mid-February, which involves at least two rounds of plowing and harrowing until soil clods are broken and the nursery site is level. A ditch system is established to ensure unimpeded irrigation and drainage. 150 kg of fermented cake fertilizer is applied as base fertilizer per mu, and 10 kg of ferrous sulfate and 3 kg of 90% crystal trichlorfon are used for soil disinfection and eradication of soil pests, respectively. Seedbeds are oriented north-south to facilitate light exposure for growth of Shaniodendron subaequale. A height of the seedbed is 25 cm, and a width of the seedbed surface is 1.2 m, with the center slightly higher than the sides to facilitate drainage. Since the seeds of Shaniodendron subaequale are small, the seedbed surface must be level.

During sowing, the seedbed surface is first sprayed with water to moisten the seedbed surface. Seeds with a 20% germination rate are evenly scattered on the seedbed surface. Due to the small quantity of seeds of Shaniodendron subaequale, they are uniformly covered with finely crushed yellow core soil with a thickness of 2 mm, followed by a layer of dry grass with a thickness of 6 mm for heat preservation and moisture retention, which facilitates seedling growth. Water is then sprayed thoroughly to soak the seedbed, which both maintains seedbed surface moisture and helps the covered dry grass lie flat on the seedbed, thereby preventing the covered dry grass from being blown away by wind. The layer of dry grass is then weighed down with branches. Fences are installed around the seedling field to prevent damage by people and livestock.

### S5, Seedling Management

7 d after sowing, the layer of dry grass is partially removed to check seedling emergence. When the cotyledons of 25% of the seedlings are unfolded, a first batch of the dry grass is removed. The dry grass removal is completed in two batches. The dry grass removal is performed on overcast days to prevent exposing the seedlings to strong sunlight on clear days. After dry grass removal, one round of weeding is performed. After a total of six weedings during the entire seedling period, the seedlings are basically canopy-closed by September. Throughout the growth period, attention is paid to cleaning ditches and drainage to prevent waterlogging of the seedlings, and timely watering or flood irrigation is carried out during droughts.

In the later stage after dry grass removal, carbendazim is sprayed once to prevent seedling damping-off. During the fast-growing period of the seedlings, a 0.3% urea foliar fertilizer is sprayed every half month. In late-September each year, a 3.0% monopotassium phosphate solution is sprayed three times to promote root growth and early lignification of the seedlings. Topdressing should follow the principle of “small amounts, multiple applications” to minimize impact on seedling growth. When pests appear, insecticides are sprayed.

### Embodiment 3

A sowing and seedling cultivation method for Shaniodendron subaequale includes the following steps.

### S1, Seed Collection

Fruits of Shaniodendron subaequale are collected in late-September.

### S2, Seed Treatment

The picked fruits are spread outdoors under weak light for sun-drying, and are turned during the process. After all fruits split open, the seeds are separated from the fruits. Seed shells and impurities are manually removed. The seeds are placed into cloth bags and hung indoors for air-drying until the seed moisture content reaches 10%, to remove surface and internal moisture.

### S3, Seed Storage

The impurities-removed and air-dried seeds are subjected to sand storage in a beginning of January of the following year, at a sand storage temperature of 10° C.
(1) River sand treatment: river sand obtained by sieving is disinfected by using a 1 g/L potassium permanganate solution.
(2) Seed treatment: seeds are soaked in a 0.5 g/L potassium permanganate solution for 0.5 h.
(3) Seed burial: a layer of the river sand from step (1) with a thickness of 5 cm is evenly spread on the ground. A layer of seeds is then spread flat on the river sand, followed by covering with a layer of the river sand from step (1) with a thickness of 3 cm. A relative humidity of the river sand is controlled at 20% during a first month of the sand storage. The relative humidity is controlled at 25% from a second month to a beginning of a third month of the sand storage. The relative humidity is controlled at 50% during a later period of the sand storage. Frequent observation is conducted to prevent the seeds from drying out or molding.
(4) Seed turning: the seeds are turned once per month to release gases such as carbon dioxide produced by seed respiration. The river sand on the seed surfaces is removed by using a rice sieve, and the seeds are disinfected again with a 0.5 g/L potassium permanganate solution before being restored to sand storage.

### S4, Sowing

A nursery site with flat terrain, good drainage, and sandy loam soil having a pH value of 6.1 is selected. Land preparation began in mid-February, which involves at least two rounds of plowing and harrowing until soil clods are broken and the nursery site is level. A ditch system is established to ensure unimpeded irrigation and drainage. 150 kg of fermented cake fertilizer is applied as base fertilizer per mu, and 10 kg of ferrous sulfate and 3 kg of 90% crystal trichlorfon are used for soil disinfection and eradication of soil pests, respectively. Seedbeds are oriented north-south to facilitate light exposure for growth of Shaniodendron subaequale. A height of the seedbed is 25 cm, and a width of the seedbed surface is 1.2 m, with the center slightly higher than the sides to facilitate drainage. Since the seeds of Shaniodendron subaequale are small, the seedbed surface must be level.

During sowing, the seedbed surface is first sprayed with water to moisten the seedbed surface. Seeds with a 30% germination rate are evenly scattered on the seedbed surface. Due to the small quantity of seeds of Shaniodendron subaequale, they are uniformly covered with finely crushed yellow core soil with a thickness of 3 mm, followed by a layer of dry grass with a thickness of 5 mm for heat preservation and moisture retention, which facilitates seedling growth. Water is then sprayed thoroughly to soak the seedbed, which both maintains seedbed surface moisture and helps the covered dry grass lie flat on the seedbed, thereby preventing the covered dry grass from being blown away by wind. The layer of dry grass is then weighed down with branches. Fences are installed around the seedling field to prevent damage by people and livestock.

### S5, Seedling Management

7 d after sowing, the layer of dry grass is partially removed to check seedling emergence. When the cotyledons of 25% of the seedlings are unfolded, a first batch of the dry grass is removed. The dry grass removal is completed in three batches. The dry grass removal is performed on overcast days to prevent exposing the seedlings to strong sunlight on clear days. After dry grass removal, one round of weeding is performed. After a total of six weedings during the entire seedling period, the seedlings are basically canopy-closed by September. Throughout the growth period, attention is paid to cleaning ditches and drainage to prevent waterlogging of the seedlings, and timely watering or flood irrigation is carried out during droughts.

In the later stage after dry grass removal, carbendazim is sprayed once to prevent seedling damping-off. During the fast-growing period of the seedlings, a 0.3% urea foliar fertilizer is sprayed every half month. In late-September each year, a 3.0% monopotassium phosphate solution is sprayed three times to promote root growth and early lignification of the seedlings. Topdressing should follow the principle of “small amounts, multiple applications” to minimize impact on seedling growth. When pests appear, insecticides are sprayed.

### Comparative Embodiment 1

A sowing and seedling cultivation method for Shaniodendron subaequale includes the following steps.

### S1, Seed Collection

Fruits of Shaniodendron subaequale are collected in early-September (i.e., 1 September to 10 September).

### S2, Seed Treatment

The picked fruits are spread outdoors under weak light for sun-drying, and are turned during the process. After all fruits split open, the seeds are separated from the fruits. Seed shells and impurities are manually removed. The seeds are placed into cloth bags and hung indoors for air-drying until the seed moisture content reaches 9%, to remove surface and internal moisture.

### S3, Seed Storage

The impurities-removed and air-dried seeds are subjected to sand storage in a beginning of January of the following year, at a sand storage temperature of 8° C.
(1) River sand treatment: river sand obtained by sieving is disinfected by using a 1 g/L potassium permanganate solution.
(2) Seed treatment: seeds are soaked in a 0.5 g/L potassium permanganate solution for 0.5 h.
(3) Seed burial: a layer of the river sand from step (1) with a thickness of 6 cm is evenly spread on the ground. A layer of seeds is then spread flat on the river sand, followed by covering with a layer of the river sand from step (1) with a thickness of 4 cm. A relative humidity of the river sand is controlled at 18% during a first month of the sand storage. The relative humidity is controlled at 23% from a second month to a beginning of a third month of the sand storage. The relative humidity is controlled at 40% during a later period of the sand storage. Frequent observation is conducted to prevent the seeds from drying out or molding.
(4) Seed turning: the seeds are turned once per month to release gases such as carbon dioxide produced by seed respiration. The river sand on the seed surfaces is removed by using a rice sieve, and the seeds are disinfected again with a 0.5 g/L potassium permanganate solution before being restored to sand storage.

### S4, Sowing

A nursery site with flat terrain, good drainage, and sandy loam soil having a pH value of 6.0 is selected. Land preparation began in mid-February, which involves at least two rounds of plowing and harrowing until soil clods are broken and the nursery site is level. A ditch system is established to ensure unimpeded irrigation and drainage. 150 kg of fermented cake fertilizer is applied as base fertilizer per mu, and 10 kg of ferrous sulfate and 3 kg of 90% crystal trichlorfon are used for soil disinfection and eradication of soil pests, respectively. Seedbeds are oriented north-south to facilitate light exposure for growth of Shaniodendron subaequale. A height of the seedbed is 25 cm, and a width of the seedbed surface is 1.2 m, with the center slightly higher than the sides to facilitate drainage. Since the seeds of Shaniodendron subaequale are small, the seedbed surface must be level.

During sowing, the seedbed surface is first sprayed with water to moisten the seedbed surface. Seeds with a 25% germination rate are evenly scattered on the seedbed surface. Due to the small quantity of seeds of Shaniodendron subaequale, they are uniformly covered with finely crushed yellow core soil with a thickness of 2 mm, followed by a layer of dry grass with a thickness of 5 mm for heat preservation and moisture retention, which facilitates seedling growth. Water is then sprayed thoroughly to soak the seedbed, which both maintains seedbed surface moisture and helps the covered dry grass lie flat on the seedbed, thereby preventing the covered dry grass from being blown away by wind. The layer of dry grass is then weighed down with branches. Fences are installed around the seedling field to prevent damage by people and livestock.

### S5, Seedling Management

7 d after sowing, the layer of dry grass is partially removed to check seedling emergence. When the cotyledons of 20% of the seedlings are unfolded, a first batch of the dry grass is removed. The dry grass removal is completed in three batches. The dry grass removal is performed on overcast days to prevent exposing the seedlings to strong sunlight on clear days. The seeds develop roots before the dry grass is removed, thereby ensuring the seedling emergence rate and increasing seedling yield. All dry grass needs to be completely removed within 20 d. Delayed removal may lead to the formation of spindly seedlings. After dry grass removal, one round of weeding is performed. After a total of six weedings during the entire seedling period, the seedlings are basically canopy-closed by September. Throughout the growth period, attention is paid to cleaning ditches and drainage to prevent waterlogging of the seedlings, and timely watering or flood irrigation is carried out during droughts.

In the later stage after dry grass removal, carbendazim is sprayed once to prevent seedling damping-off. During the fast-growing period of the seedlings, a 0.3% urea foliar fertilizer is sprayed every half month. In late-September each year, a 3.0% monopotassium phosphate solution is sprayed three times to promote root growth and early lignification of the seedlings. Topdressing should follow the principle of “small amounts, multiple applications” to minimize impact on seedling growth. When pests appear, insecticides are sprayed.

### Comparative Embodiment 2

A sowing and seedling cultivation method for Shaniodendron subaequale includes the following steps.

### S1, Seed Collection

Fruits of Shaniodendron subaequale are collected in early-October.

### S2, Seed Treatment

The picked fruits are spread outdoors under weak light for sun-drying, and are turned during the process. After all fruits split open, the seeds are separated from the fruits. Seed shells and impurities are manually removed. The seeds are placed into cloth bags and hung indoors for air-drying until the seed moisture content reaches 9%, to remove surface and internal moisture.

### S3, Seed Storage

The impurities-removed and air-dried seeds are subjected to sand storage in a beginning of January of the following year, at a sand storage temperature of 2° C.
(1) River sand treatment: river sand obtained by sieving is disinfected by using a 1 g/L potassium permanganate solution.
(2) Seed treatment: seeds are soaked in a 0.5 g/L potassium permanganate solution for 0.5 h.
(3) Seed burial: a layer of the river sand from step (1) with a thickness of 6 cm is evenly spread on the ground. A layer of seeds is then spread flat on the river sand, followed by covering with a layer of the river sand from step (1) with a thickness of 4 cm. A relative humidity of the river sand is controlled at 16% during the sand storage.
(4) Seed turning: the seeds are turned once per month to release gases such as carbon dioxide produced by seed respiration. The river sand on the seed surfaces is removed by using a rice sieve, and the seeds are disinfected again with a 0.5 g/L potassium permanganate solution before being restored to sand storage.

### S4, Sowing

A nursery site with flat terrain, good drainage, and sandy loam soil having a pH value of 5.8 is selected. Land preparation began in mid-February, which involves at least two rounds of plowing and harrowing until soil clods are broken and the nursery site is level. A ditch system is established to ensure unimpeded irrigation and drainage. 150 kg of fermented cake fertilizer is applied as base fertilizer per mu, and 10 kg of ferrous sulfate and 3 kg of 90% crystal trichlorfon are used for soil disinfection and eradication of soil pests, respectively. Seedbeds are oriented north-south to facilitate light exposure for growth of Shaniodendron subaequale. A height of the seedbed is 25 cm, and a width of the seedbed surface is 1.2 m, with the center slightly higher than the sides to facilitate drainage. Since the seeds of Shaniodendron subaequale are small, the seedbed surface must be level.

During sowing, the seedbed surface is first sprayed with water to moisten the seedbed surface. Seeds with a 20% germination rate are evenly scattered on the seedbed surface. Due to the small quantity of seeds of Shaniodendron subaequale, they are uniformly covered with finely crushed yellow core soil with a thickness of 2 mm, followed by a layer of dry grass with a thickness of 5 mm for heat preservation and moisture retention, which facilitates seedling growth. Water is then sprayed thoroughly to soak the seedbed, which both maintains seedbed surface moisture and helps the covered dry grass lie flat on the seedbed, thereby preventing the covered dry grass from being blown away by wind. The layer of dry grass is then weighed down with branches. Fences are installed around the seedling field to prevent damage by people and livestock.

### S5, Seedling Management

7 d after sowing, the layer of dry grass is partially removed to check seedling emergence. When the cotyledons of 20% of the seedlings are unfolded, a first batch of the dry grass is removed. The dry grass removal is completed in three batches. The dry grass removal is performed on overcast days to prevent exposing the seedlings to strong sunlight on clear days. The seeds develop roots before the dry grass is removed, thereby ensuring the seedling emergence rate and increasing seedling yield. All dry grass needs to be completely removed within 20 d. Delayed removal may lead to the formation of spindly seedlings. After dry grass removal, one round of weeding is performed. After a total of six weedings during the entire seedling period, the seedlings are basically canopy-closed by September. Throughout the growth period, attention is paid to cleaning ditches and drainage to prevent waterlogging of the seedlings, and timely watering or flood irrigation is carried out during droughts.

In the later stage after dry grass removal, carbendazim is sprayed once to prevent seedling damping-off. During the fast-growing period of the seedlings, a 0.3% urea foliar fertilizer is sprayed every half month. In late-September each year, a 3.0% monopotassium phosphate solution is sprayed three times to promote root growth and early lignification of the seedlings. Topdressing should follow the principle of “small amounts, multiple applications” to minimize impact on seedling growth. When pests appear, insecticides are sprayed.

### Comparative Embodiment 3

A sowing and seedling cultivation method for Shaniodendron subaequale includes the following steps.

### S1, Seed Collection

Fruits of Shaniodendron subaequale are collected in early-October.

### S2, Seed Treatment

The picked fruits are spread outdoors under weak light for sun-drying, and are turned during the process. After all fruits split open, the seeds are separated from the fruits. Seed shells and impurities are manually removed. The seeds are placed into cloth bags and hung indoors for air-drying until the seed moisture content reaches 9%, to remove surface and internal moisture.

### S3, Seed Storage

The impurities-removed and air-dried seeds are subjected to sand storage in a beginning of January of the following year, at a sand storage temperature of 2° C.
(1) River sand treatment: river sand obtained by sieving is disinfected by using a 1 g/L potassium permanganate solution.
(2) Seed treatment: seeds are soaked in a 0.5 g/L potassium permanganate solution for 0.5 h.
(3) Seed burial: a layer of the river sand from step (1) with a thickness of 6 cm is evenly spread on the ground. A layer of seeds is then spread flat on the river sand. The process of laying a layer of river sand and a layer of seeds is repeated cyclically, stacking 3 to 4 layers. Finally, the stack is covered with a layer of the river sand from step (1) with a thickness of 4 cm. A relative humidity of the river sand is controlled at 18% during a first month of the sand storage. The relative humidity is controlled at 25% from a second month to a beginning of a third month of the sand storage. The relative humidity is controlled at 40% during a later period of the sand storage.

### S4, Sowing

A nursery site with flat terrain, good drainage, and sandy loam soil having a pH value of 6.1 is selected. Land preparation began in mid-February, which involves at least two rounds of plowing and harrowing until soil clods are broken and the nursery site is level. A ditch system is established to ensure unimpeded irrigation and drainage. 150 kg of fermented cake fertilizer is applied as base fertilizer per mu, and 10 kg of ferrous sulfate and 3 kg of 90% crystal trichlorfon are used for soil disinfection and eradication of soil pests, respectively. Seedbeds are oriented north-south to facilitate light exposure for growth of Shaniodendron subaequale. A height of the seedbed is 25 cm, and a width of the seedbed surface is 1.2 meters (m), with the center slightly higher than the sides to facilitate drainage. Since the seeds of Shaniodendron subaequale are small, the seedbed surface must be level.

During sowing, the seedbed surface is first sprayed with water to moisten the seedbed surface. Seeds with a 20% germination rate are evenly scattered on the seedbed surface. Due to the small quantity of seeds of Shaniodendron subaequale, they are uniformly covered with finely crushed yellow core soil with a thickness of 2 mm, followed by a layer of dry grass with a thickness of 5 mm for heat preservation and moisture retention, which facilitates seedling growth. Water is then sprayed thoroughly to soak the seedbed, which both maintains seedbed surface moisture and helps the covered dry grass lie flat on the seedbed, thereby preventing the covered dry grass from being blown away by wind. The layer of dry grass is then weighed down with branches. Fences are installed around the seedling field to prevent damage by people and livestock.

### S5, Seedling Management

7 d after sowing, the layer of dry grass is partially removed to check seedling emergence. When the cotyledons of 20% of the seedlings are unfolded, a first batch of the dry grass is removed. The dry grass removal is completed in two batches. The dry grass removal is performed on overcast days to prevent exposing the seedlings to strong sunlight on clear days. The seeds develop roots before the dry grass is removed, thereby ensuring the seedling emergence rate and increasing seedling yield. All dry grass needs to be completely removed within 20 d. Delayed removal may lead to the formation of spindly seedlings. After dry grass removal, one round of weeding is performed. After a total of six weedings during the entire seedling period, the seedlings are basically canopy-closed by September. Throughout the growth period, attention is paid to cleaning ditches and drainage to prevent waterlogging of the seedlings, and timely watering or flood irrigation is carried out during droughts.

In the later stage after dry grass removal, carbendazim is sprayed once to prevent seedling damping-off. During the fast-growing period of the seedlings, a 0.3% urea foliar fertilizer is sprayed every half month. In late-September each year, a 3.0% monopotassium phosphate solution is sprayed three times to promote root growth and early lignification of the seedlings. Topdressing should follow the principle of “small amounts, multiple applications” to minimize impact on seedling growth. When pests appear, insecticides are sprayed.

In order to further demonstrate the effectiveness of the method provided by the disclosure in improving the seed germination rate and the seedling emergence rate of Shaniodendron subaequale, the inventors conduct seedling cultivation experiments by using the aforementioned three embodiments and three comparative embodiments. These experiments test the effects of the different seedling cultivation methods on seed plumpness, thousand-seed weight, seedling emergence rate, and seedling survival rate. The test results are shown in Table 1 below.

TABLE 1
Effect of different seedling cultivation methods on the
seedling emergence rate and seedling survival
rate of Shaniodendron subaequale

| | | | Seedling | Seedling |
|---|---|---|---|---|
| | Seed | Thousand-seed | emergence | survival |
| | plumpness | weight | rate | rate |
| | (%) | (g) | (%) | (%) |
| Embodiment 1 | 86 | 28 | 85 | 98 |
| Embodiment 2 | 63 | 22 | 80 | 95 |
| Embodiment 3 | 71 | 23 | 83 | 96 |
| Comparative | 58 | 20 | 37 | 77 |
| embodiment 1 | | | | |
| Comparative | 78 | 24 | 73 | 79 |
| embodiment 2 | | | | |
| Comparative | 78 | 24 | 74 | 78 |
| embodiment 3 | | | | |

It can be seen from the results from Table 1 that the seedling emergence rates and the seedling survival rates in embodiments 1 to 3 are relatively high. In embodiment 1, the seed collection time is early-October. At this time, the leaves of Shaniodendron subaequale turn red, the fruits become yellowish, and some fruits are cracked open to reveal the seeds. Measurements indicate that the seeds collected at this time have an average plumpness of 86% and a thousand-seed weight of 28 g, which demonstrates high seed maturity, rich nutrient content, and healthy seeds with strong germination capacity. Consequently, the sowing and seedling cultivation method of the embodiment 1 achieves the highest seedling emergence rate and seedling survival rate, at 85% and 98%, respectively.

In the comparative embodiment 1, the seed collection time is early-September. At this time, although the leaves of Shaniodendron subaequale show signs of aging and reddening, the fruits are yellowish and exhibited characteristics of maturity, the measured seed plumpness is only 58%. The seeds are not fully mature, leading to reduced germination capability and lower seedling survival rates.

The seedling emergence rate and the seedling survival rate obtained by the sowing and seedling cultivation method of the comparative embodiment 2 are also relatively low, which may due to a lower sand storage temperature, thereby slowing the physiological processes of the seeds, inhibiting the activity of internal enzymes and consequently delaying germination speed. Furthermore, the relative humidity of the river sand is maintained at a consistently low level, which may lead to insufficient water absorption by the seeds, thereby adversely affecting germination. Thus, the seedling emergence rate is lower, the quality of emerged seedlings is poor, which further impacted seedling growth, resulting in a seedling survival rate of only 79%.

The seedling emergence rate and the seedling survival rate obtained by the sowing and seedling cultivation method of the comparative embodiment 3 are also relatively low, which may due to the absence of repeated turning and disinfection during the seed storage, thereby resulting in inadequate ventilation, causing carbon dioxide accumulation toxicity, mold, deterioration, and other issues, which results in a seedling emergence rate of only 74%.

Apparently, those skilled in the art can make various modifications and variations to the disclosure without departing from a spirit and a scope of the disclosure. Thus, when these modifications and variations of the disclosure fall within the scope of the claims and their equivalent technologies, the disclosure is also intended to include these modifications and variations.

What is claimed is:

1. A sowing and seedling cultivation method for Shaniodendron subaequale, comprising:
seed collection: collecting seeds of Shaniodendron subaequale from mid-September to early-October each year;
seed treatment: removing impurities and air-drying the seeds until a seed moisture content is 8% to 10%;
seed storage: performing sand storage on disinfected seeds for overwintering by using a sand-seed-sand layering method; controlling a relative humidity to 15% to 20% during a first month of the sand storage, controlling the relative humidity to 21% to 25% from a second month to a beginning of a third month of the sand storage, and controlling the relative humidity to 30% to 50% during a later period of the sand storage; and performing turning and disinfection on the disinfected seeds during the sand storage to obtain seeds after sand storage;
sowing: sowing the seeds after sand storage on a seedbed when a seed germination rate reaches 20% to 30% in a following year, and covering the seeds after sand storage with a layer of soil and a layer of dry grass, sequentially; and
seedling management: removing the layer of dry grass gradually when cotyledons of 20% to 30% of seedlings are unfolded, and performing the seedling management.

2. The sowing and seedling cultivation method for Shaniodendron subaequale as claimed in claim 1, wherein the layering method in the seed storage comprises:
laying the disinfected seeds on a layer of disinfected river sand with a thickness of 5 centimeters (cm) to 8 cm, and covering a layer of the disinfected river sand with a thickness of 3 cm to 4 cm on the disinfected seeds.

3. The sowing and seedling cultivation method for Shaniodendron subaequale as claimed in claim 1, wherein the performing turning and disinfection on the disinfected seeds during the sand storage to obtain seeds after sand storage in the seed storage comprises:
taking out the seeds after sand storage, removing river sand from surfaces of the seeds after sand storage to obtain cleaned seeds, disinfecting the cleaned seeds by soaking in a potassium permanganate solution with a concentration of 0.3 grams per liter (g/L) to 0.5 g/L for 30 minutes (min) to 40 min to obtain re-disinfected seeds, and restoring the re-disinfected seeds to sand storage according to the layering method.

4. The sowing and seedling cultivation method for Shaniodendron subaequale as claimed in claim 1, wherein the turning and disinfection is performed once per month during the seed storage.

5. The sowing and seedling cultivation method for Shaniodendron subaequale as claimed in claim 1, wherein a temperature of the sand storage is in a range of 6° C. to 10° C.

6. The sowing and seedling cultivation method for Shaniodendron subaequale as claimed in claim 1, wherein the seedbed is applied with 140 kilograms (kg) to 160 kg of cake fertilizer, 8 kg to 12 kg of plant iron supplement, and 2 kg to 3 kg of organophosphorus insecticide per mu.

7. The sowing and seedling cultivation method for Shaniodendron subaequale as claimed in claim 6, wherein the cake fertilizer is a fermented cake fertilizer selected from the group consisting of rapeseed cake, bean cake, sesame cake, peanut cake, and cottonseed cake.

8. The sowing and seedling cultivation method for Shaniodendron subaequale as claimed in claim 1, wherein the seedling management further comprises: spraying a bactericide after removing the layer of dry grass, applying a nitrogen fertilizer during a fast-growing period of the seedlings, and applying a phosphorus-potassium fertilizer in late-September.
